(19) United States
(12) Patent Application Publication
(10) Pub. No.: US 2008/0007885 A1
(43) Pub. Date: Jan. 10, 2008

(54) System for improving LED illumination reliability in projection display systems

(75) Inventors: David Joseph Mehrl, Plano, TX (US); Michael Richard Douglass, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/481,373

(22) Filed: Jul. 5, 2006

(51) Int. Cl. H02H 5/04

(52) U.S. Cl. 361/104

(57) ABSTRACT

System and method for increasing the reliability of LED illumination systems used in projection display systems. A preferred embodiment comprises a light source with one or more serially connected sequences of two or more light elements coupled to a power source. Each light element includes a light emitting diode and an antifuse coupled in parallel to the light emitting diode, wherein the antifuse short circuits if a current flowing through the antifuse exceeds a specified magnitude. The current exceeds the specified magnitude only if an open circuit type failure occurs in the light emitting diode and the short circuit of the antifuse creates a low-resistance current path, thereby preserving current flow through the serially connected sequence and keeping the remaining light elements illuminated.

### TECHNICAL FIELD

The present invention relates generally to a system and method for displaying images, and more particularly to a system and method for increasing the reliability of the LED illumination systems used in projection display systems.

### BACKGROUND

Projection display systems make use of a bright light source to project images to be displayed onto a display plane. A commonly used light source is an electric arc lamp. These lamps can produce an extremely bright light that maximizes the brightness of the images in the projection display system. However, electric arc lamps can be expensive and normally have a life expectancy of a few thousand hours. Furthermore, electric arc lamps cannot be rapidly cycled on and off and can therefore restrict the performance of the projection display system.

Light emitting diodes (LEDs) are being used in some newly available projection display systems. LEDs offer several significant advantages over electric arc lamps, such as comparatively low power requirements, the ability to rapidly switch on and off, and long useful life expectancy. With reference to FIG. 1, there is shown a diagram illustrating a portion of a prior art projection display system. The diagram shown in FIG. 1 illustrates a lighting system of a projection display system, which can include a light source 105 and an integrating rod 110. The integrating rod 110 can combine the light produced by the light source 105 and make the light more diffuse. The light from the light source 105, after passing through the integrating rod 110, can illuminate an array of spatial light modulators 115. The array of spatial light modulators 115 can modify the light from the light source 105 based on the images to be displayed. The light, as modified by the array of spatial light modulators 115, can then be viewed on a display plane (not shown).

However, a single LED usually cannot provide an adequate amount light for use in a projection display system. Therefore, projection display systems will usually use multiple LEDs to replace a single electric arc lamp. With reference now to FIG. 2a, there is shown a prior art light source 105, wherein multiple LEDs are used in place of a single light source. The light source 105 comprises sixteen (16) LEDs. Although the light source 105 features sixteen LEDs, other light sources may make use of other numbers of LEDs. The LEDs in the light source 105 are arranged in four parallel connected sequences (such as sequence 205) of LEDs (such as LED 210), wherein each sequence comprises four LEDs connected in series. Furthermore, the use of multiple LEDs can enable the use of LEDs that produce different colors of light, thereby creating a multi-color light source and potentially eliminating the need for color filters.

One disadvantage of the prior art is that with the use of multiple LEDs in place of a single light source, although LEDs have a longer useful life expectancy, the use of multiple LEDs can increase the probability of failure. For example, if the probability of failure of a single LED is p, then if sixteen LEDs are used in a light source, the probability of failure of a single LED in the sixteen LEDs is 16*p. Furthermore, although the LEDs themselves can have a long useful life expectancy, other failure modes are possible. For example, the electrical contacts between a circuit board and the LEDs can fail due to stresses related to thermal cycling, thermal shock and differing coefficients of thermal expansion between different materials.

Another disadvantage of the prior art is that with the use of serially connected LEDs, if one LED fails due to an open circuit type of fault, then all of the LEDs in the sequence will stop functioning. With reference now to FIG. 2b, there is shown a diagram illustrating a prior art light source 105 with an LED 210 that has failed. With the open circuit failure of the LED 210, the remaining LEDs (for example, LED 215, 216, and 217) also stop working, as shown in FIG. 2c, due to failure of the LED 210 breaking the current path through the sequence 205. When multiple LEDs stop operating, the amount of light produced by the light source 105 can decrease to an unacceptable level or the light source 105 may not be able to produce a desired color.

### SUMMARY OF THE INVENTION

These and other problems are generally solved or circumvented, and technical advantages are generally achieved, by preferred embodiments of the present invention which provides a system and method for improving the reliability of the LED illumination systems used in projection display systems.

In accordance with a preferred embodiment of the present invention, a light source is provided. The light source includes a serially connected sequence of two or more light elements, with each light element including a light emitting diode and an antifuse coupled in parallel to the light emitting diode. The antifuse changes into a short circuit if a current flowing through the antifuse exceeds a specified magnitude.

In accordance with another preferred embodiment of the present invention, a display system is provided. The display system includes a light source, an array of light modulators optically coupled to the light source, and a controller coupled to the array of light modulators. The array of light modulators creates images by setting each light modulator in the array to a state for displaying an image on a display plane and the controller issues commands to control the operation of the array of light modulators. The light source includes a serially connected sequence of two or more light elements, with each light element including a light emitting diode and an antifuse coupled in parallel to the light emitting diode.

In accordance with another preferred embodiment of the present invention, a method for bypassing a light emitting diode (LED) is provided. The method includes providing a first current through the LED in a first current path, generating a light with the LED in response to the first current, and when the LED or its connections fail with an open circuit, creating with an antifuse a second current path in parallel with the first current path to bypass the open circuit. The method also includes providing a second current through the second current path.

An advantage of a preferred embodiment of the present invention is that if an LED in a sequence of LEDs fails, the failed LED can be bypassed and the remaining LEDs in the sequence can remain in operation. Therefore, the advantages of using a long sequence of LEDs (for example, a power supply with a high voltage but low current) can be maintained.

A further advantage of a preferred embodiment of the present invention is that the present invention can be implemented very simply and at low cost. Therefore, the implementation of the present invention can involve very little modification to the manufacturing process and at very little cost.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a lighting portion of a projection display system;

FIGS. 2a through 2c are diagrams of a multi-LED implementation of a light source and the effect of a failure of a single LED in the light source;

FIGS. 3a and 3b are diagrams of a light element with an apparatus for bypassing a failed LED, according to a preferred embodiment of the present invention;

FIGS. 4a though 4c are diagrams of exemplary light sources, according to a preferred embodiment of the present invention;

FIG. 5 is a diagram of a display system, according to a preferred embodiment of the present invention; and

FIG. 6 is a diagram of a method for bypassing an LED, according to a preferred embodiment of the present invention.

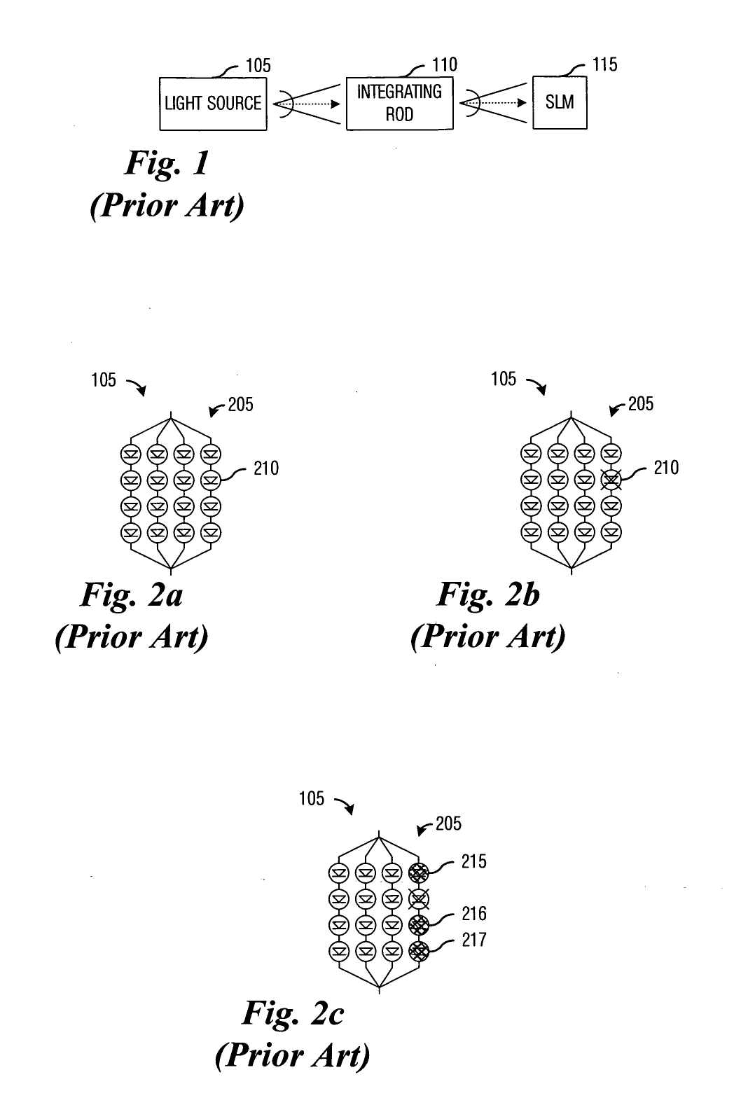

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a projection display system and method utilizing a light source comprising multiple LEDs. The present invention can be used in any type of projection display system, such as projection display systems utilizing one of a wide variety of microdisplays, including digital micromirror devices, deformable mirrors, liquid crystal displays, liquid crystal on silicon, and so forth. The invention may also be applied, however, to other systems, wherein there is a need for bypassing a failed component in a sequence of components and maintaining operation of the sequence, such as a sequence of lights, and so forth. For example, the present invention can be utilized in a light source wherein sequences of standard lights are used in the light source.

In addition, the present invention can find use in applications that involve large arrays of high power LEDs, such as in automotive applications (LED brake lights or headlights, for example), traffic lights, LED lamp fixtures that are designed to replace household incandescent light bulbs, and so forth. In the case of LED lamp fixtures, long strings of serially connected LEDs can be wired with household 120 VAC supplies that perform direct conversion of AC to DC (for example, a simple four-diode full-wave bridge rectifier can be used). The long string of serially connected LEDs can be directly driven and cost savings can be achieved by negating the need for a switching mode buck regulator or some other power conversion circuitry. In these types of applications, the present invention can be useful for increasing reliability.

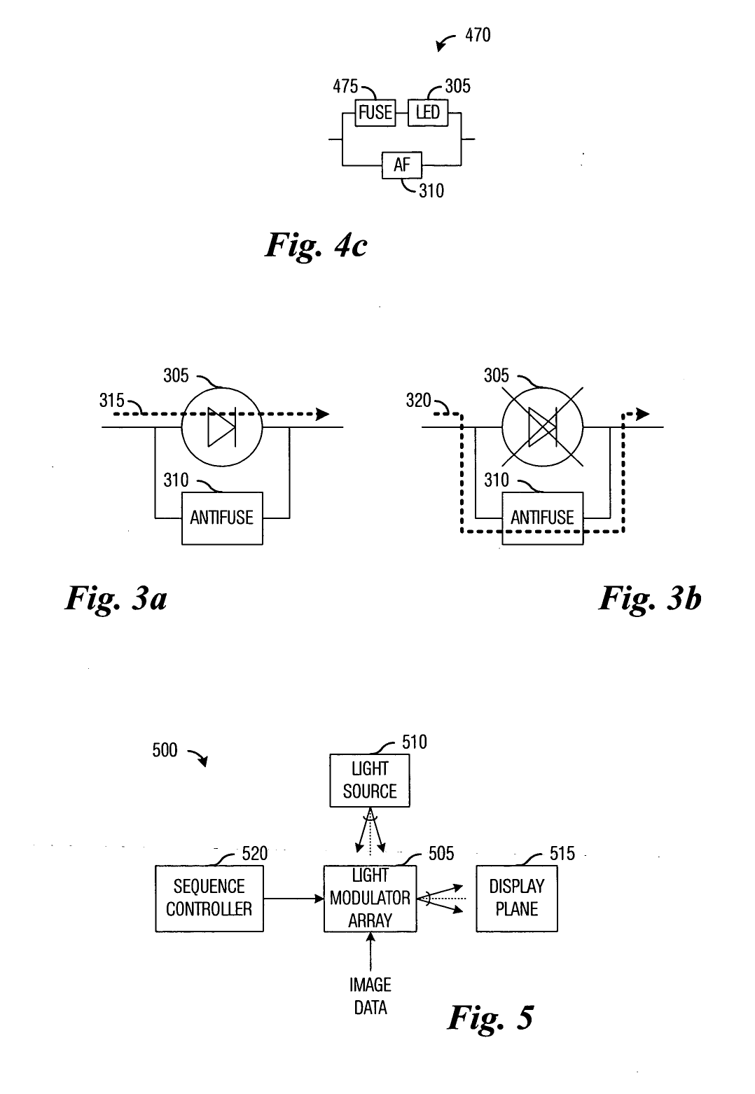

With reference now to FIGS. 3a and 3b, there are shown diagrams illustrating a light element, wherein the light element includes an apparatus for bypassing a failed LED, according to a preferred embodiment of the present invention. The diagram shown in FIG. 3a illustrates the light element, which includes an LED 305 and an antifuse 310. The LED 305 can comprise one or more LEDs, which illuminates when a current 315 is provided across its terminals.

In order to provide the needed amount of light for use in a projection display system, the LEDs typically require a large current. As a result of the large current, the LEDs can get hot. Furthermore, a common way to illuminate the LEDs is to rapidly pulse the LEDs on and off. For example, it may be required to pulse the LED 305 with short duration pulses when it is desired to display a minimum amount of light. The rapid current pulses and the resulting heating, can force the LED 305 through a large number of thermal cycles, which includes heating up and then cooling down. The rapid succession of heating/cooling can subject the LED 305 to thermal shock. Additionally, conductors inside the LED 305 as well as solder connections, bond wires, and so forth, which connect the LED 305 to a circuit board, also undergo the thermal cycles and the attendant thermal shock. Therefore, the conductors, solder connections, and bond wires can fail. A failure of the conductors and/or the solder connections can have the same net result as the failure of the LED 305.

The antifuse 310, while the LED 305 is operating within design specifications, can have a resistance that is significantly higher than the resistance of the LED 305 so that the majority of the current, preferably almost all of the current, passes through the LED 305. The antifuse 310 can be made from a material that contains a powered conductive material that will normally have a large resistance, for example.

Alternatively, the antifuse 310 can be made from a multilayered member that typically lies across a pair of electrical terminals. The antifuse 310 can contain a layer of a highly resistive material, such as a resistive film, that will provide the high resistance when the LED 305 is operating properly. Then, if the LED 305 fails as an open circuit, the current flowing through the resistive film would increase and cause the resistive film to heat up. Another layer of the multilayered member may be made from a material that will deform when heated. Therefore, when excessive current flows through the antifuse 310 (the resistive film layer), the heat sensitive layer will deform and physically (mechanically) attach the deformable layer of the multilayered member to the electrical terminals, creating a low-resistance current path.

In yet another alternative, the antifuse 310 can contain a layer of a material that is electrostrictive in nature, and when an electric field of sufficient magnitude is applied (as from increased current flow due to the failed LED 305), the electrostrictive layer can deform and can create a low-resistance current path around the failed LED 305. Additionally, if properly selected, a current of sufficient magnitude can cause a spot weld and permanently affix the antifuse 310 in the position where it would provide a low-resistance current path. Other materials that can be used include piezoelectric materials and ferroelectric materials.

The antifuse 310 can also be implemented as a solid-state device. One such example of a solid-state antifuse would be a silicon controlled rectifier (SCR). The SCR (functioning as the antifuse 310) can be placed parallel to the LED 305 and while the LED 305 is operating properly, the SCR would remain substantially inoperative. However, when the LED 305 has an open circuit failure, the SCR would see an increased voltage drop and would begin to conduct current. Although the SCR is a temporary device, wherein the SCR would reset itself should power be removed, if the LED 305 remains an open circuit, then the SCR would return to its current conducting state shortly after the power is reapplied to the LED 305 and SCR combination.

When the LED 305 has an open circuit failure, which may be a result of a failure of the LED 305 and/or a failure of conductors and/or solder connections of the LED 305, the current path 315 through the LED 305 is no longer present. Therefore, the current that originally flowed through the LED 305 will now flow through the antifuse 310 (as shown as current path 320 (FIG. 3b)). The additional current flowing through the high resistance of the antifuse 310 causes the antifuse 310 to dissipate more heat. The additional current and the resulting additional heat can cause the resistance of the antifuse 310 to decrease. For example, if the antifuse 310 is made from a material that contains a powered conductive material, then the additional current and heat can cause the powered conductive material to melt and become a contiguous conductor, turning the antifuse 310 from a partial conductor with a high resistance into a conductor with a low resistance.

Although the antifuse 310 is shown in FIGS. 3a and 3b as being used in conjunction with a single LED (LED 305), an antifuse can be used with multiple LEDs. For example, it is possible to couple a single antifuse across the terminals of multiple LEDs (such as, one antifuse for every two, three, four, and so on, LEDs) connected in series. This can reduce the number of antifuses used in a light source, potentially reducing the cost of implementing the light source as well as reducing the physical size of the light source. In light sources with large numbers of LEDs, this technique can significantly reduce the number of antifuses needed.

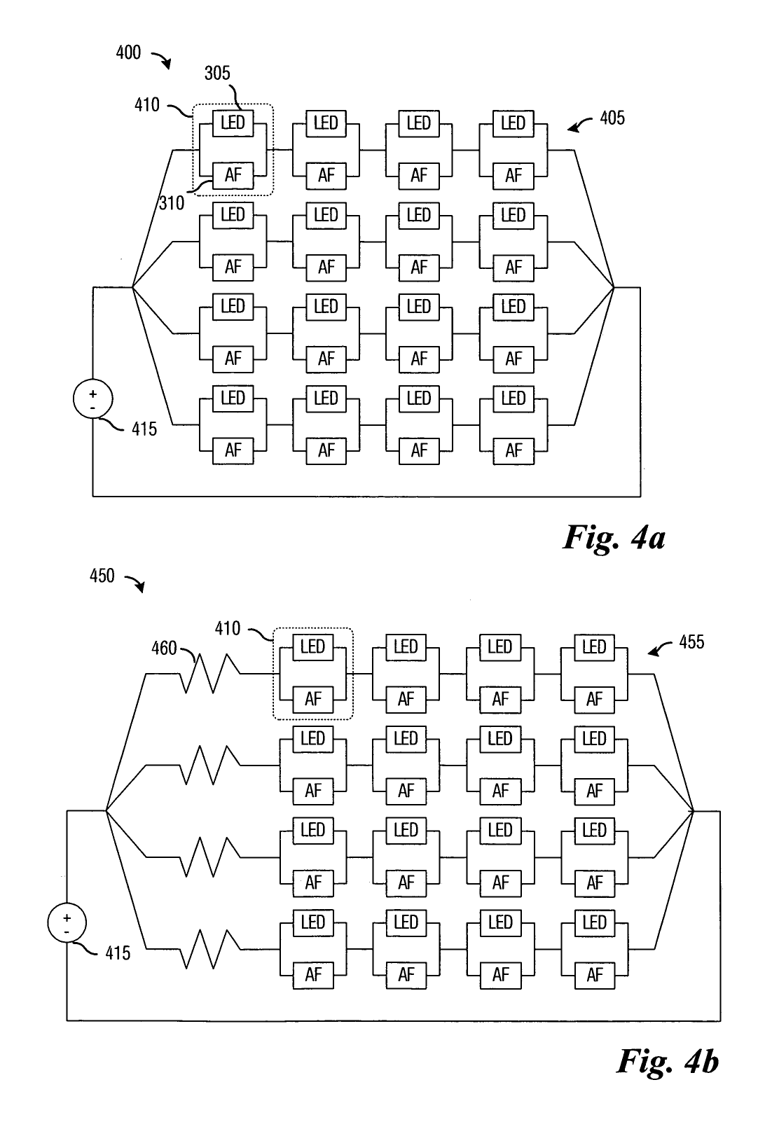

With reference now to FIGS. 4a and 4b, there are shown diagrams illustrating exemplary light sources, wherein the light sources feature an apparatus for bypassing failed LEDs, according to a preferred embodiment of the present invention. The diagram shown in FIG. 4a illustrates a light source 400 comprising four sequences of light elements, such as sequence 405, with each sequence being made up of four light elements serially connected. Each light element, such as light element 410, is made up of an LED, such as LED 305, and an antifuse, such as antifuse 310. Therefore, should any LED in the light source 400 have an open circuit failure, an antifuse associated with the LED will allow the bypassing of the failed LED. The light source 400 can be powered by a power supply 415.

Generally, when an LED, such as the LED 305, has an open circuit failure and an associated antifuse, such as the antifuse 310, short circuits, the current flowing through the remaining LEDs in the sequence 405 changes (is increased). The increased current flow will, at least, alter the amount of light emitted by the remaining LEDs, or at worst, shorten the life of the remaining LEDs. Therefore, the power supply 415 should ideally adjust to alter (or maintain) the current flow so that the current flowing through the remaining LEDs does not increase significantly so as to shorten the useful life of the remaining LEDs.

The diagram shown in FIG. 4b illustrates a light source 450 arranged in a similar fashion to the light source 400. The light source 450 comprises four sequences of light elements, such as sequence 455, with each sequence being powered by the power supply 415. However, each sequence also includes a resistor, such as resistor 460, which can permit the use of the light source 450 in low cost applications. The resistor 460 can function as a current limiting resistor. The resistor 460 can help to keep the current in the sequence 455 substantially constant in the case that an LED in the sequence fails and is replaced by an antifuse. Alternatively, it is possible to replace the resistor 460 with a commercially available current regulating diode device, which can maintain a constant current if one or more LEDs have an open circuit failure, leading to associated antifuses short circuiting.

Although the heretofore-discussed failure of an LED (plus potentially, attendant connections, such as circuit board leads, conductors, and so forth) results in the LED turning into an open circuit, another common failure of LEDs can result in the LED turning into a short circuit. In such a situation, the failed LED will continue to conduct. Although the short circuit failure of an LED will not cause an entire string of serially connected LEDs to fail, the change in the current flowing through the serially connected string can expedite failures of other LEDs in the serially connected string.

With reference now to FIG. 4c, there is shown a diagram illustrating a light element 470 that can be a part of a serially connected string of LEDs, wherein the light element 470 can be used in place of the light element 410 (FIGS. 4a and 4b) and provide the ability to compensate for both forms of LED failure, according to a preferred embodiment of the present invention. The light element 470 can be directly substituted for the light element 410 in the light source 400.

The light element 470 includes an LED 305 and an antifuse 310 arranged in a parallel configuration as in the light element 410. However, connected in series with the LED 305 is a fuse 475, which can have a typical fuse behavior, wherein the fuse 475 will open circuit when a current exceeding some specified amount flows through the fuse 475. Therefore, when the LED 305 fails and turns into a short circuit, the current flowing through the light element 470 will increase (due to the decreased resistance) and cause the fuse 475 to become an open circuit (blow).

The blowing of the fuse 475 will open circuit the portion of the light element 470 containing the fuse 475 and the LED 305, leading to an increased current flowing through the antifuse 310. When the current flowing through the antifuse 310 exceeds a specified amount, the antifuse 310 will short circuit and reconnect the serially connected string of LEDs that contains the light element 470.

Alternatively, if a light source includes a large number of strings of LEDs, a single fuse can be used with each string of LEDs. In this situation, when an LED fails as a short circuit, the fuse in the string can blow and turn off the entire string of LEDs. While this may reduce the number of operating LEDs, the removal of the string of LEDs containing the failed LED can allow the remaining strings of LEDs to operate in a normal manner and at normal conditions, which could help to prevent the failure of additional LEDs.

With reference now to FIG. 5, there is shown a diagram illustrating an exemplary projection display system 500, wherein the display system 500 utilizes an array of micromirror light modulators 505 (also referred to as a digital micromirror device (DMD)), according to a preferred embodiment of the present invention. The individual light modulators in the DMD 505 assume a state that corresponds to image data for an image being displayed by the display system 500, wherein, depending upon the image data, an individual light modulator can either reflect light from a light source 510 away from or towards a display plane 515. The light source 510 can be implemented using LEDs and can include an apparatus for bypassing failed LEDs. If the light source 510 is a wide-band light source, then spinning color filters (not shown) can be used to provide needed light, while a narrow-band light source can be capable of producing needed colors of light without the use of color filters, by electrically switching various LED colors on or off in a proper sequence. A combination of the reflected light from all of the light modulators in the DMD 505 produces an image corresponding to the image data. A sequence controller 520 coordinates the loading of the image data into the DMD 505, controlling the light source 510, and so forth.

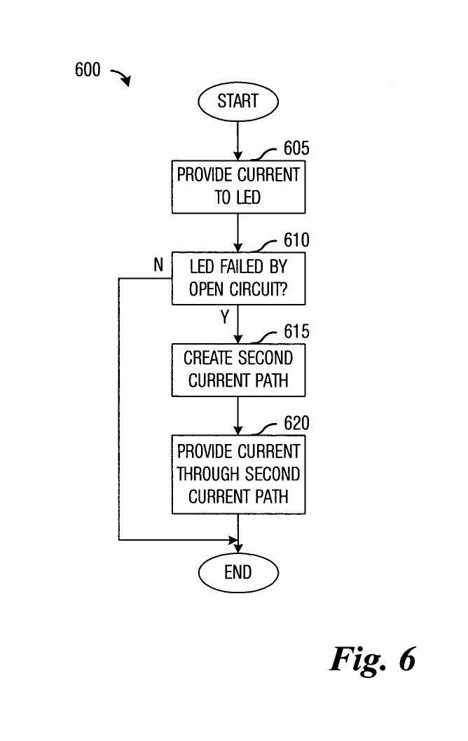

With reference now to FIG. 6, there is shown a diagram illustrating a sequence of events 600 in the bypassing of an LED, according to a preferred embodiment of the present invention. The sequence of events 600 can be illustrative of the bypassing of a failed LED, wherein the failure of the LED or its attendant connections results in an open circuit. The sequence of events 600 can begin with the providing of a first current to the LED to illuminate the LED (block 605). However, if the LED or any of its connections should fail and create an open circuit (block 610), it is necessary to create a second current path that is parallel to the LED (block 615). It is now possible to bypass the failed LED (or its connections) by providing a current through the second current path (block 620).

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A light source comprising:
a serially connected sequence of two or more light elements coupled to a power source, wherein each light element comprises
a light emitting diode, and
an antifuse coupled in parallel to the light emitting diode, the antifuse configured to short circuit if a current flowing through the antifuse exceeds a specified magnitude.

2. The light source of claim 1, wherein the light source comprises two or more serially connected sequences of light elements, and wherein the sequences of light elements are coupled in parallel.

3. The light source of claim 1, wherein the antifuse has a high resistance when the current flowing through the antifuse is less than the specified magnitude.

4. The light source of claim 1, wherein the antifuse comprises a mixture containing a conductive powder that will melt into a conductor when the current flowing through the antifuse exceeds the specified magnitude.

5. The light source of claim 1, wherein the antifuse comprises an electromechanically active material that deforms when an electric field of a specified magnitude is applied, and wherein the deformation of the antifuse results in the creation of a low-resistance current path through the antifuse.

6. The light source of claim 1, wherein the antifuse comprises:
a thin film resistor, the thin film resistor configured to produce heat proportional to current flowing through a heat sensitive material; and
a heat sensitive material coupled to the thin film resistor, the heat sensitive material configured to deform under the presence of heat and create a low-resistance current path when sufficient heat is produced by the thin film resistor.

7. The light source of claim 1, wherein the antifuse comprises a silicon controlled rectifier, the silicon controlled rectifier configured to begin conducting when a voltage drop across the silicon controlled rectifier exceeds a second specified magnitude.

8. The light source of claim 1 further comprising a fuse coupled in series with the light emitting diode and in parallel with the antifuse, the fuse configured to open circuit if a second current flowing through the fuse exceeds a second specified magnitude.

9. The light source of claim 1, wherein each light emitting diode comprises a sequence of two or more serially coupled light emitting diodes, and wherein the respective antifuse is coupled in parallel to each sequence of serially coupled light emitting diodes.

10. The light source of claim 1, wherein the power source provides power to illuminate the light emitting diodes in the light elements, and wherein the power source adjusts to maintain a substantially consistent current through the remaining light emitting diodes when an antifuse short circuits.

11. A display system comprising:
a light source comprising a serially connected sequence of two or more light elements coupled to a power source, wherein each light element comprises
a light emitting diode, and
an antifuse coupled in parallel to the light emitting diode;
an array of light modulators optically coupled to the light source, wherein the array of light modulators creates images by setting each light modulator in the array to a state for displaying an image on a display plane by modulating light from the light source; and
a controller coupled to the array of light modulators, the controller configured to issue commands to control the operation of the array of light modulators.

12. The display system of claim 11, wherein when the first current is less than the specified magnitude, the antifuse has a high resistance.

13. The display system of claim 12, wherein when the first current exceeds the specified magnitude, the antifuse short circuits.

14. The display system of claim 11, wherein the array of light modulators is a digital micromirror device.

15. The display system of claim 11, wherein the array of light modulators is a liquid crystal display array.

16. The display system of claim 11, wherein the array of light modulators is a liquid crystal on silicon array.

17. A method for bypassing a light emitting diode (LED), the method comprising:
providing a first current through the LED in a first current path;
generating a light with the LED in response to the first current;
when the LED or its connections fail with an open circuit, creating with an antifuse a second current path in parallel with the first current path to bypass the open circuit; and
providing a second current through the second current path.

18. The method of claim 17 further comprising after the generating, when the LED fails with a closed circuit, creating with a fuse in series with the LED a second open circuit.

19. The method of claim 18 further comprising after the creating of the open circuit with the fuse, creating with the antifuse the second current path in parallel with the first current path to bypass the second open circuit and the failed LED.

20. The method of claim 17, wherein the antifuse changes from a high-resistance current path to a low-resistance current path when a current flowing through the antifuse exceeds a specified magnitude.
